(19) United States
(12) Patent Application Publication
(10) Pub. No.: US 2006/0165021 A1
(43) Pub. Date: Jul. 27, 2006

(54) Effective point coordination function in wireless lan

(76) Inventors: Jianbo Tian, Shanghai (CN); Qunli Jia, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/540,051

(22) PCT Filed: Dec. 15, 2003
(86) PCT No.: PCT/IB03/06093

§ 371 Date: Dec. 19, 2005

(30) Foreign Application Priority Data
Dec. 26, 2002 (CN) 02159786.3

(51) Int. Cl. H04B 7/00

(52) U.S. Cl. 370/310

(57) ABSTRACT

This invention provides a system and method for enhancing point coordination function in wireless LANs. A contention procedure is introduced into PCF in this invention. When the point coordinator (PC) polls the mobile terminal who has no frame to send, the terminal does not respond to the CF-Poll from PC, and will adjust its NAV and set it to a special value that is defined as SPIFS. When data is ready on this mobile terminal, the terminal can contend for accessing the medium. If it detects the medium to be idle for SPIFS period during the CFP, then the mobile terminal gains the control of medium and starts to send the ready data. So this mobile terminal can have another opportunity to gain the control of medium during this CFP instead of next CFP, and this can decrease the transmission delay.

### TECHNICAL FIELD

This invention is related to the field of wireless LANs, especially the system and method for enhancing point coordination function in wireless LANs.

### BACKGROUND OF THE INVENTION

IEEE802.11 wireless LANs standard is now widely accepted, and is applied to all fields. There are two methods of coordination functions in the framework of transmission Media Access control (MAC) of IEEE802.11 standard, namely Distributed Coordination Function (DCF) and Point Coordination Function (PCF). The two methods coexist in wireless LANs of IEEE802.11 standard. Since the Point Coordination Function is able to provide contention-free frame transfer, it can be used to support real time traffic such as Audio and Video. Point Coordinator (PC) is used in this access method, which serves as a base station in Basic Service Set (BSS) to determine which mobile terminal is entitled to send. Point Coordinator gains the control of medium at the beginning of a Contention Free Period (CFP), whose waiting interval (set by PC itself) between two transmissions is shorter than that of every mobile terminal at Distributed Coordination Function. Thus, Point Coordinator can keep the control of medium through the Contention Free Period (CFP). In a Basic Service Set (BSS), all mobile terminals except Point Coordinator set their Network Allocation Vector (NAV) to CFP Max Duration at the beginning of a CFP. This best prevents the mobile terminal from contending for accessing the medium, and ensures that only the Point Coordinator obtains the control of medium. A typical frame transmission in Contention Free Period is described in FIG. 1. It can be observed from FIG. 1 that Point Coordinator starts to detect transmission medium at the beginning of every Contention Free Period. When a free PCF Inter-Frame Space (PIFS) in transmission medium is detected, Point Coordinator will gain the control of medium and send a beacon frame, which contains Contention Free (CF) parameter setup and Delivery Traffic Indication Message (DTIM). After sending the initial beacon frame, Point Coordinator will wait for at least a Short Inter-Frame Space (SIFS), and then start to poll each mobile terminal according to the polling list. When a mobile terminal is polled, it will send data frame after a SIFS. If the mobile terminal has no data to send, it will send back a Null. In another case, if it has no data to send and needs to acknowledge the CF-Poll frame, the terminal will send a CF-ACK frame no data back to Point Coordinator. Therefore, if a mobile terminal has data to send after its polling period, it has to wait until getting control of the medium in next Contention Free Period or Contention Period (CP). Thus, the transmission delay of real time traffic is prolonged.

### SUMMARY OF THE INVENTION

This invention provides a method for enhancing point coordination function in wireless LANs. In a Contention Free Period, when a mobile terminal has data to send after its poll period, and there is at least another mobile terminal in the same period, which is polled but does not respond to the Point Coordinator, this mobile terminal, by adjusting its variables, may have another opportunity to gain the control of medium and start to send data frame during this CFP, instead of next CFP or CP. In this way, the transmission delay can be decreased.

Another purpose of this invention is to provide a system for enhancing point coordination function in wireless LANs to decrease the transmission delay of the system by the method of this invention.

The realization of the invention:

The method for enhancing point coordination function in wireless LANs, and is used for under a wireless LAN protocol, including contention free period (CFP) and contention period (CP). It includes the following steps:

a. In a contention free period, when a mobile terminal is polled by Point Coordinator of the access point(AP) and has no data to send, it will adjust its variable to a predetermined value;

b. When the data frames are ready for transmission, the mobile terminal starts to detect the shared medium. When the medium is free, this variable starts to count;

c. When the variable counts to the value and the medium is still free, the said mobile terminal gains the control of medium and start to send data frame.

The benefit of this invention is: during a CFP, by adjusting the variable of a mobile terminal to a predetermined value, the terminal can contend for accessing the medium as soon as it gets the data ready. If the medium detected is idle enough during the CFP, the mobile terminal gains the control of medium and starts to send the ready data. So there is no need to wait until next CFP to send data, decreasing the transmission delay.

### BRIEF DESCRIPTION OF THE DRAWINGS

The invention is explained in further detail, and by way of example, with reference to the accompanying drawings wherein:

FIG. 1 is an explanatory diagram showing an ordinary frame transfer in the CFP.

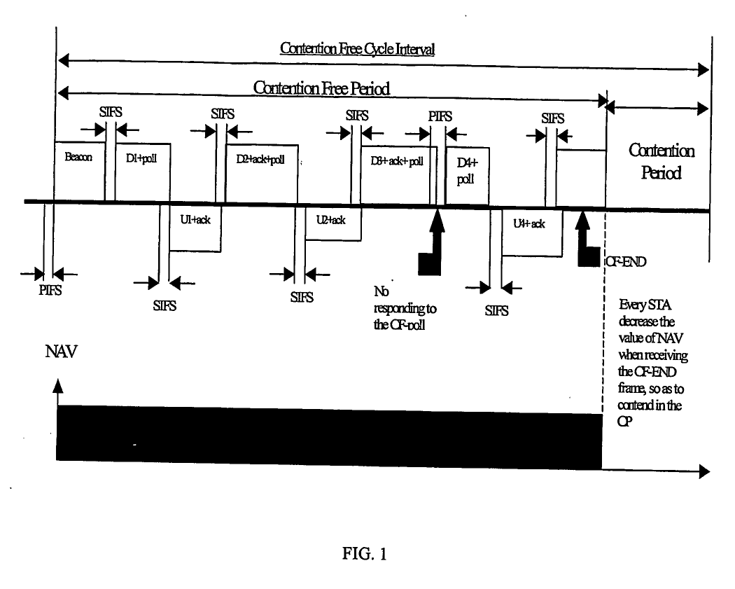

FIG. 2 is an explanatory diagram showing a frame transfer in the CFP according to the present invention.

FIG. 3 is a flowchart showing the process of appending a mobile terminal to the list according to the present invention.

FIG. 4 is a block diagram showing the system for enhancing point coordination function in wireless LANs according to the present invention.

FIG. 5 is a block diagram showing the structure of the mobile terminal according to the present invention.

FIG. 6 is a block diagram showing the structure of the Access Point according to the present invention.

### DETAILED EMBODIMENT OF THE PREFERRED EMBODIMENTS

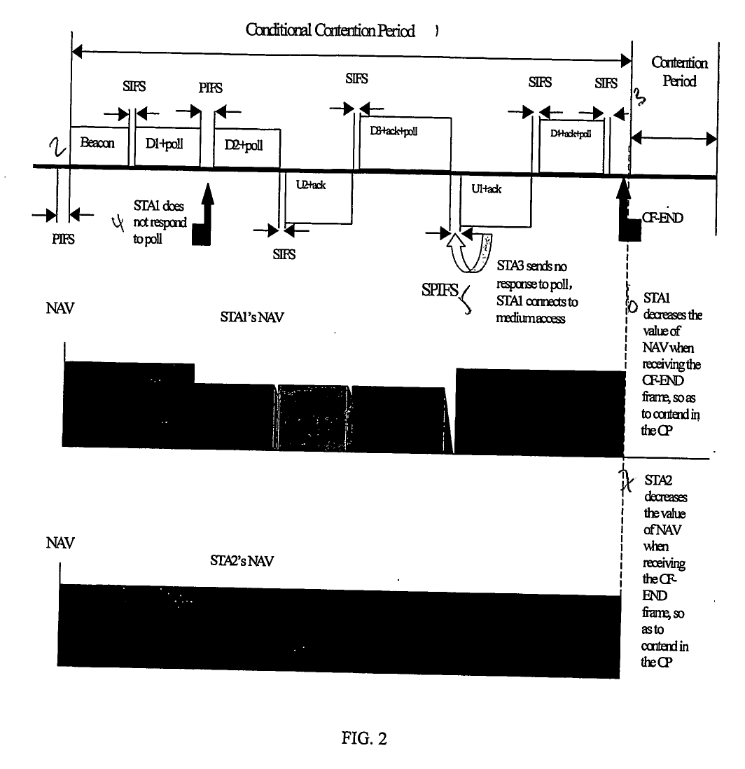

As shown in FIG. 2, at the beginning of a CFP, Point Coordinator gets the control of medium at the end of PIFS period, and then sends a beacon frame. After sending the initial beacon frame, the Point Coordinator will wait for a SIFS and then start to poll STA1, which is the first mobile terminal in the polling list. If it has no data frame to send, STA1 does not respond to the poll from PC, and will set its NAV to a value defined as SPIFS. The NAV value will be frozen until data on this mobile terminal is ready.

Because it didn't get any response from STA1, the Point Coordinator will poll next mobile terminal STA2 in the polling list. If the data frames on the STA1 are ready for transmission during the time when STA2 is being polled, STA1 starts to detect the medium. So, when the PC completes the polling and the transmission medium enter the idle state, STA1 starts counting back. The idle time of the shared medium is SIFS, and the STA1's NVA value is SPIFS. As defined before, PIFS is longer than SIFS, so STA2 gets the control of medium and sends data to the PC. When STA1 find the shared medium become busy again after a SIFS period, STA1 reset its NAV to SPIFS and continue to detect the medium. This indicates that if another terminal has data to send when polled by the PC, STA1 has no chance to get the control of medium.

Later, the Point Coordinator continues polling to STA3. If STA3 has no data to send, in other words, it does not respond to the polling of PC, the medium will be idle for PIFS period. Since SPIFS is shorter than PIFS, STA1 will get the control of medium after a SPIFS, and then start to send data frames to the PC. Thus, if the other mobile terminal such as STA3 does not respond to the PC when it is polled, STA1 can have the opportunity to gain control of medium and send the data during this CFP. In the end of this CFP, the mobile terminal sets its NAV to a value corresponding to Distributed coordination function Inter-Frame Space (DIFS), and then contends for the control of the medium.

In view of the problem that at least one mobile terminal might get the control of the medium at the same time, the point coordinator in this invention establishes a table in the following way: when the point coordinator polls the mobile terminals which have no frame to send and do not respond to the polling from it, the point coordinator will append these mobile terminals to the table in turn. Because all mobile terminals in the table might get the control of medium, so when they do get the control at the same time, conflict occurs. The probability of conflict increases as the number of mobile terminals in the table gets larger. Therefore, the point coordinator limits the number of the mobile terminals in the table below a predetermined threshold value. In order to decrease the probability of conflict to the greatest extent, the threshold value is generally set at a small number. When the number of the mobile terminals in the table reaches the threshold, the point coordinator will send a special control frame (Thresholdout) to other mobile terminals that do not respond to the poll of the point coordinator, forbidding them to change their NAV. Thereby the mobile terminal couldn't contend for the control of medium during the CFP. When conflict occurs among the mobile terminals in the table, the mobile terminals need to re-send data during the next CFP. When conflict occurs between the point coordinator and the mobile terminal in the table, the mobile terminal need not re-send data during this CFP, and the PC starts to detect the shared medium. If the idle time of the medium is PIFS, point coordinator will get the control of medium again and start to poll next mobile terminal. In the end of the CFP, the point coordinator clears the table.

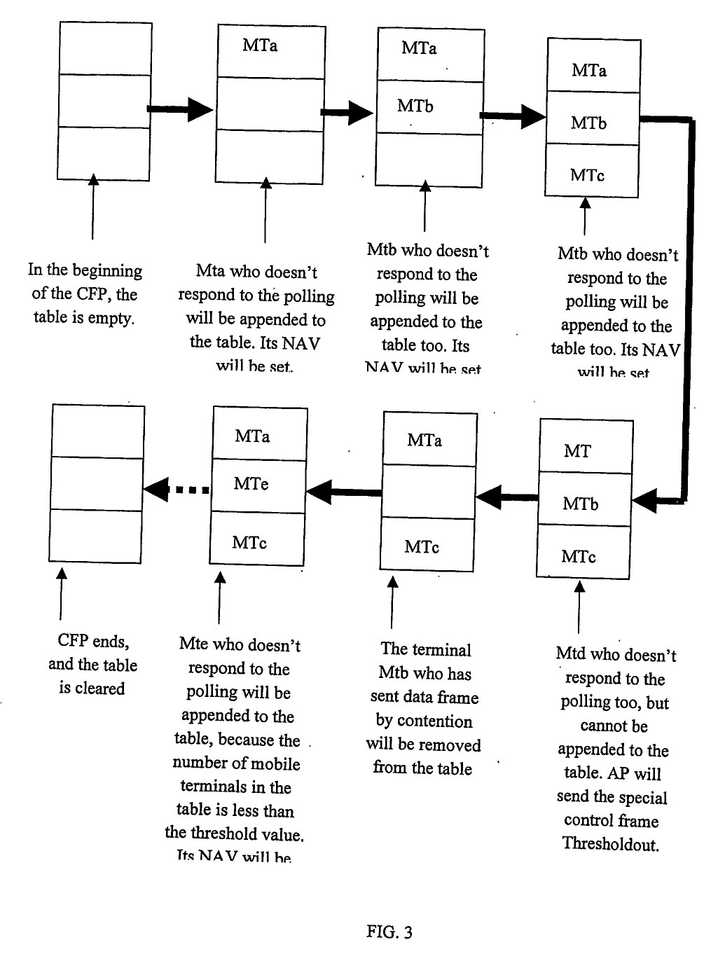

As shown in FIG. 3, the threshold value of the table is set at 3 in a certain wireless LAN. At the beginning, this table is empty. A mobile terminal Mta does not respond to the polling from PC, and will be appended to the table. If there are two more mobile terminals Mtb and Mtc who do not respond to the polling from PC, they both can still be appended to the table, because the present number of mobile terminals in the table is less than the threshold value. All the mobile terminals NAV in the table can contend equally for the control of medium. However, if there is one more mobile terminal later who does not respond to the polling from PC, the terminal cannot be appended to the table and it will receive a special control frame, which forbids the terminal to change its NAV. So the terminal will not contend during the CFP. In this way, the number of the mobile terminals contending will be limited, and the probability of conflict will be decreased. In the table, the terminal Mtb who have sent data frame by contention will be removed from the table, so the number of mobile terminals in the table will be smaller than the threshold value. If there is another mobile terminal, such as Mte, who gives no response, it can be appended to the table. The table is useless during the CF and will be cleared when the last CFP is finished. If there are still mobile terminals in the table when the CFP ends, their NAVs are set smaller than those of the other mobile terminals so as to increase their contention power in contention period and decrease transmission delay.

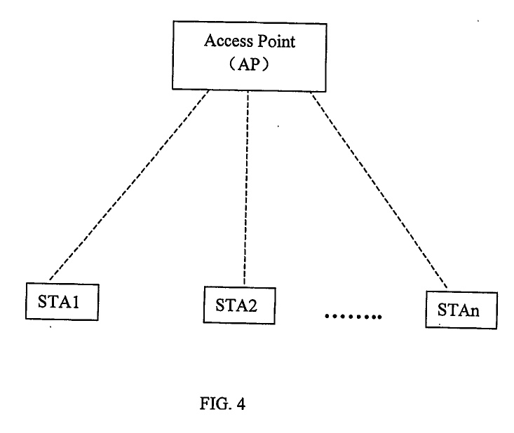

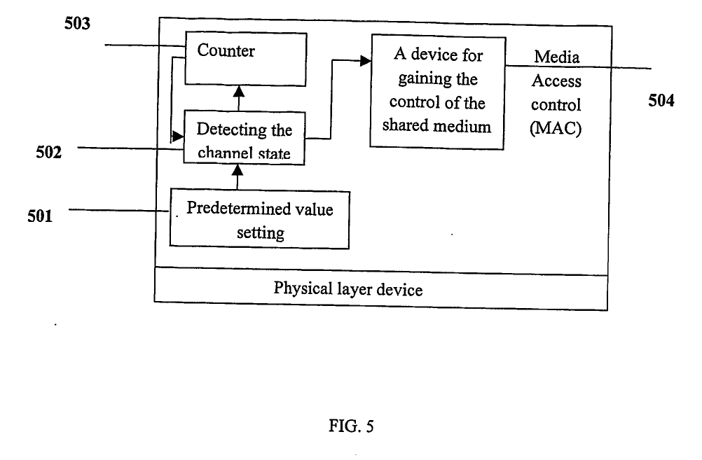

FIG. 4 is a block diagram showing the system for enhancing point coordination function in wireless LANs according to the present invention, which includes an access point (AP) 40 and several mobile terminals (STA). As shown in FIG. 5, a mobile terminal (STA) contains:

A predetermined value setting and adjusting device 501, which in a contention free period will adjust the NAV of a mobile terminal to SPIFS, when the mobile terminal is polled by the point coordinator of an access point (AP) and have no data to send;

A counter 503, when the data frames are ready for transmission, the mobile terminal starts to detect the shared medium, and when the medium is ideal, the counter starts counting down from the value corresponding to the SPIFS;

A device 504 for gaining the control of the medium, when the counter counts to a predetermined value, such as 0, and the shared medium is still free, which is detected by a device 502 for detecting the channel state, the device gains the control of the medium and starts to send data frame.

After the mobile terminal (STA) gains the control of medium and sends data frame during the CFP, it will reset its NAV to the maximum CFP value.

The value corresponding to SPIFS is defined between short inter-frame space (SIFS) and PCF inter-frame space (PIFS): SIFS<SPIFS<PIFS. SPIFS is achieved by the following equation:
SPIFS=SIFS+[1slot*Rand( )]

Where Rand( ) is a pseudo random number drawn from a uniform distribution over the interval [0,1].

During the contention free period, once the predetermined value setting device 501 adjusts the variable to a predetermined value, it does not change its NAV even if it receives another beacon frame at the target beacon transmission time(TBTT).

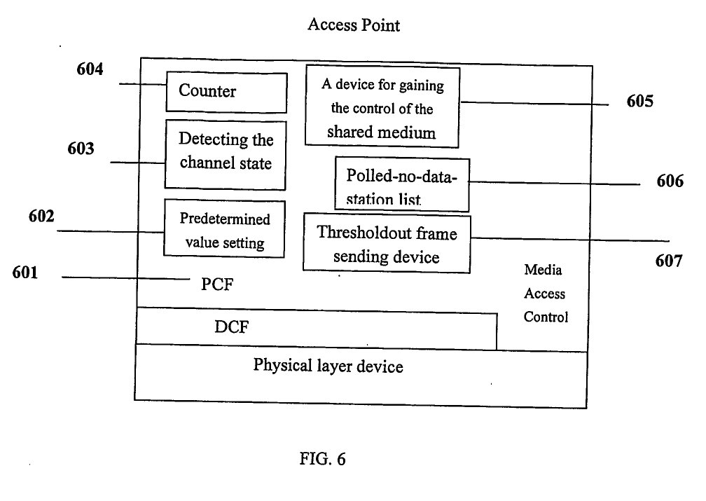

As shown in FIG. 6, besides a predetermined value setting and adjusting device 602; a device 603 for detecting the channel state; a counter 604 and a device 605 for gaining the control of the medium, a access point (AP) also comprises a point coordinator 601. Poll-no-data-station table 606 and the device 607 for sending the frame Thresholdout.

The point coordinator 601 determines that a certain quantity of mobile terminals can contend for the control of the medium, which is accomplished as follows: the point coordinator 601 establishes a table 606, to which the mobile terminals who have no data frame to send in CFP when the point coordinator is polling are appended in turn, and it limits the number of the mobile terminals in the table below a predetermined threshold value, such as 3.

When the number of the mobile terminals in the table reaches the threshold, the point coordinator 601 will let the device 607 for sending frame Thresholdout to send a control signal to other mobile terminals who do not respond to the polling, forbidding them to change their NAV.

In the end of the CFP, the NAV of the mobile terminal who sent data frame by contention during CFP period is set to a value corresponding to distributed coordination function inter-frame space (DIFS). When the NAVs of all the mobile terminals are set to this value corresponding to DIFS, if there are still mobile terminals in the table, their NAVs will be set smaller than those of the other mobile terminals so as to increase their contention power in contention period. In the end, the point coordinator 601 clears the table.

What is claimed is:

1. A method for enhancing point coordination function in wireless LANs, which is used for a wireless LAN protocol, including contention free period(CFP) and contention period(CP), said method includes following steps:
a. In a contention free period, when a mobile terminal is polled by an access point(AP) and has no data to send, it will adjust its variable to predetermined value;
b. When the data frames are ready for transmission, the mobile terminal starts to detect the share medium, when the share medium is free, the said variable starts to count;
c. If said variable counts to a determined value and the share medium is still free, then the said mobile terminal gains the control of medium and start to send data frame.

2. A method of claim 1 for enhancing point coordination function in wireless LANs, wherein said variable is the network allocation vector(NAV) of the mobile terminal.

3. A method of claim 2 for enhancing point coordination function in wireless LANs, wherein after said station gains the control of medium and starts to send data frame in this CFP, it adjusts its NAV to the maximum value.

4. A method of claim 1 for enhancing point coordination function in wireless LANs, wherein said predetermined value is the value corresponding to the SPIFS.

5. A method of claim 4 for enhancing point coordination function in wireless LANs, wherein the value corresponding to SPIFS is defined between short inter-frame space(SIFS) and PCF inter-frame space (PIFS): SIFS<SPIFS<PIFS.

6. A method of claim 5 for enhancing point coordination function in wireless LANs, wherein SPIFS is achieved by the following equation:
SPIFS=SIFS+[1slot*Rand( )]
Where Rand( ) is a pseudo random number drawn from a uniform distribution over the interval [0,1].

7. A method of claim 1 for enhancing point coordination function in wireless LANs, wherein in step a after the mobile terminal adjusts its variable to a predetermined value, in contention free period, it does not change its NAV even if it receives another beacon frame at the target beacon transmission time(TBTT).

8. A method of claim 1 for enhancing point coordination function in wireless LANs, wherein the point coordinator determines that a number of stations can contend for the control of the shared medium.

9. A method of claim 8 for enhancing point coordination function in wireless LANs, wherein said point coordinator establishes a table, to which mobile terminals who have no data frame to send in CFP period when the point coordinator is polling are appended in turn.

10. A method of claim 9 for enhancing point coordination function in wireless LANs, wherein the point coordinator limits the number of the stations in the table lower than a predetermined threshold value.

11. A method of claim 10 for enhancing point coordination function in wireless LANs, wherein when the number of the mobile terminals in the table reaches the said threshold, the point coordinator will send a control signal to those who do not respond to the poll of the point coordinator, forbidding them to change said variable.

12. A method of claim 11 for enhancing point coordination function in wireless LANs, wherein in CFP period, if a mobile terminal in the table manages to send data frame by contention, it will be removed from the table.

13. A method of claim 12 for enhancing point coordination function in wireless LANs, wherein in the end of CFP, the variable of the mobile terminal who sent data frame by contention in CFP period is set to a value corresponding to distributed (coordination function) inter-frame space(DIFS) and then contends for the control of the shared medium in the contention period.

14. A method of claim 13 for enhancing point coordination function in wireless LANs, wherein when the variables of all the mobile terminals are set to the values corresponding to DIFS, if there are still some mobile terminals in the table, then the variables of them are set smaller than those of the other mobile terminals so as to increase their contention power in contention period.

15. A method of claim 14 for enhancing point coordination function in wireless LANs, wherein in the end of the CFP, the point coordinator clears the table.

16. A method of claim 1 for enhancing point coordination function in wireless LANs, wherein said wireless network protocol is IEEE802.11 protocol.

17. A wireless LAN system with enhanced point coordination function (EPCF), which includes an access point (AP) and several mobile terminals, said mobile terminal also comprises:
A predetermined value setting and adjusting device, which in a contention free period will adjust the variable of a mobile terminal to predetermined value so as to control a counter when said mobile terminal is polled by an access point (AP) and have no data to send;
A counter, when the data frames are ready for transmission, the mobile terminal starts to detect the shared medium, and when the shared medium is free, said counter starts counting;
A device for gaining the control of the shared medium, If the said counter counts to a predetermined value and the shared medium is still free, said device gains the control of the medium and starts to send data frame.

18. A wireless LAN system with enhanced point coordination function of claim 17, wherein said variable is network allocation vector (NAV) of the mobile terminal.

19. A wireless LAN system with enhanced point coordination function of claim 18, wherein after said mobile terminal gains the control of medium and starts to send data frame in said CFP, it adjusts its NAV to the maximum value.

20. A wireless LAN system with enhanced point coordination function of claim 17, wherein said predetermined value is the value corresponding to the SPIFS.

21. A wireless LAN system with enhanced point coordination function of claim 20, wherein the value corresponding to SPIFS is defined between short inter-frame space(SIFS) and PCF inter-frame space(PIFS): SIFS<SPIFS<PIFS.

22. A wireless LAN system with enhanced point coordination function of claim 21, wherein SPIFS is achieved by the following equation:
SPIFS=SIFS+[1slot*Rand( )]
Where Rand( ) is a pseudo random number drawn from a uniform distribution over the interval [0,1].

23. A wireless LAN system with enhanced point coordination function of claim 17, wherein in the contention free period once the predetermined value setting device adjusts said variable to a predetermined value, it does not change its NAV even if it receives another beacon frame at the target beacon transmission time(TBTT).

24. A wireless LAN system with enhanced point coordination function of claim 17, wherein said point coordinator determines that a certain quantity of mobile terminals can contend for the control of the shared medium.

25. A wireless LAN system with enhanced point coordination function of claim 24, wherein said point coordinator establishes a table, to which the mobile terminals who have no data frame to send in CFP when the point coordinator is polling are appended in turn.

26. A wireless LAN system with enhanced point coordination function of claim 25, wherein the point coordinator limits the number of the mobile terminals in the table lower than a predetermined threshold value.

27. A wireless LAN system with enhanced point coordination function of claim 26, wherein said access point includes a control signal sending device, when the number of the station in the table reaches said threshold, the point coordinator will send a control signal to other mobile terminals who do not respond to the poll of the point coordinator, forbidding them to change said variable.

28. A wireless LAN system with enhanced point coordination function of claim 27, wherein in the end of CFP, the variable of the mobile terminal who sent data frame by contention in CFP period is set to a value corresponding to distributed coordination function inter-frame space(DIFS).

29. A wireless LAN system with enhanced point coordination function of claim 28, wherein when the variables of all the mobile terminals are set to the values corresponding to DIFS, if there are still mobile terminals in the table, then their variables are set smaller than those of the other mobile terminals so as to increase their contention power in contention period.

30. A wireless LAN system with enhanced point coordination function of claim 29, wherein in the end of the CFP, the point coordinator clears the table.

31. A wireless LAN system with enhanced point coordination function of claim 17, wherein said wireless network protocol is IEEE802.11 protocol.
